(19) United States
(12) Patent Application Publication
(10) Pub. No.: US 2026/0273790 A1
(43) Pub. Date: Sep. 17, 2026

(54) SYSTEMS AND METHODS FOR PUNCTURING PACKAGING TAPE ON A PACKAGING BOX

(71) Applicant: Walmart Apollo, LLC, Bentonville, AR (US)

(72) Inventors: Jinhong Saw, Fayetteville, AR (US); Gerald J. Byers, Springfield, MO (US)

(21) Appl. No.: 19/466,050

(22) Filed: Jan. 30, 2026

Related U.S. Application Data
(60) Provisional application No. 63/752,135, filed on Jan. 31, 2025.

(51) Int. Cl. B26F 1/24

(52) U.S. Cl. CPC B26F 1/24

(57) ABSTRACT

Systems, apparatuses, and methods are disclosed for puncturing packaging tape on a packaging box. Some embodiments include a roller having a cylindrical body with first and second bases and a curved side interconnecting the bases. The curved side includes a plurality of puncturing elements extending radially therefrom, a raised central ridge extending circumferentially around the curved side, and first and second tapered portions extending from an apex of the raised central ridge toward the respective bases. When the roller is applied to and moved along packaging tape on a packaging box, the puncturing elements perforate the packaging tape to facilitate opening of the box. The roller may be manually operated or incorporated into an automated system including a conveyor and a support frame that positions the roller relative to packaging boxes moving on the conveyor.

### CROSS-REFERENCE TO RELATED APPLICATIONS

This application claims the benefit of U.S. Provisional Application No. 63/752,135, filed Jan. 31, 2025, which is incorporated herein by reference in its entirety.

### BACKGROUND

Packaging boxes used throughout modern supply chains are commonly sealed using pressure-sensitive packaging tape. While such tape provides reliable closure during transport and handling, it often presents difficulties during opening, particularly in high-throughput fulfillment environments. Conventional approaches for facilitating box opening include cutting, tearing, slicing, or chemically or thermally weakening the tape. These approaches can be imprecise, space-inefficient, or incompatible with automated workflows, and may risk damage to box contents or even injury to personnel. Manual cutting tools introduce safety concerns, while automated cutting systems tend to be complex, costly, and difficult to integrate into existing packaging lines.

### BRIEF DESCRIPTION OF DRAWINGS

Various examples will be described below with reference to the following figures:

FIG. 1 depicts a front perspective view of a roller system in accordance with some embodiments;

FIG. 2 depicts a rear perspective view of the roller system of FIG. 1;

FIG. 3 depicts a side cross-sectional view of a roller system in accordance with some embodiments;

FIG. 4 shows a manual roller system in accordance with some embodiments positioned at a first end of a packaging box and in contact with the packaging tape of the packaging box prior to being rolled along the packaging box and puncturing the packaging tape;

FIG. 5 shows the roller system of FIG. 4 positioned at a second end of a packaging box and still in contact with the packaging tape of the packaging box after being rolled along the packaging box and puncturing the packaging tape;

FIG. 6 shows a front perspective view of an automated roller system in accordance with some embodiments;

FIG. 7 shows a front perspective view of another automated roller system in accordance with some embodiments;

FIG. 8A is flowchart depicting an example method of puncturing packaging tape on a packaging box in accordance with some embodiments; and

FIG. 8B is flowchart depicting another example method of puncturing packaging tape on a packaging box in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Although certain actions and/or steps may be described or depicted in a particular order of occurrence, those actions and/or steps are not limited to that order and may be performed in a different order or occurrence. The terms and expressions used herein have the ordinary technical meaning as is accorded to such terms and expressions except where different specific meanings have otherwise been set forth herein.

### DETAILED DESCRIPTION

Generally speaking, pursuant to various embodiments, systems, apparatuses, and methods are provided herein useful to puncturing packaging tape on a packaging box. In some embodiments, a roller system for puncturing packaging tape on a packaging box includes: a roller with a cylindrical body having a first base with a first diameter, a second base having a second diameter and located opposite the first base, and first and second diameters being equal, and a curved side interconnecting the first base and the second base, the curved side including: a plurality of puncturing elements disposed on a surface of the curved side and extending radially therefrom, the puncturing elements to puncture the packaging tape when the roller is applied to and rolled over the packaging tape of the packaging box; a raised central ridge continuously extending around a circumference of the curved side; a first tapered portion extending from an apex of the raised central ridge to the first base; and a second tapered portion extending from the apex of the raised central ridge to the second base.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

In some embodiments, a method of puncturing packaging tape on a packaging box includes: contacting the packaging tape with a roller, the roller comprising: a cylindrical body having a first base with a first diameter, a second base having a second diameter and located opposite the first base, and first and second diameters being equal, and a curved side interconnecting the first base and the second base, the curved side including: a plurality of puncturing elements disposed on a surface of the curved side and extending radially therefrom, the puncturing elements to puncture the packaging tape when the roller is applied to and roller over the packaging tape of the packaging box; a raised central ridge continuously extending around a circumference of the curved side; a first tapered portion extending from an apex of the raised central ridge to the first base; and a second tapered portion extending from the apex of the raised central ridge to the second base; moving the roller along the packaging tape while the puncturing elements of the roller are in contact with the packaging tape; and puncturing the packaging tape on the packaging box via the puncturing elements of the roller during the moving the roller along the packaging tape while the puncturing elements of the roller are in contact with the packaging tape.

In some embodiments, a roller system for puncturing packaging tape on a packaging box includes a roller with a cylindrical body having a first base with a first diameter, a second base having a second diameter and located opposite the first base, and first and second diameters being equal, and a curved side interconnecting the first base and the second base. The curved side includes: a plurality of puncturing elements disposed on a surface of the curved side and extending radially therefrom, the puncturing elements to puncture the packaging tape when the roller is applied to and rolled over the packaging tape of the packaging box; a raised central ridge continuously extending around a circumference of the curved side; a first tapered portion extending from an apex of the raised central ridge to the first base; and a second tapered portion extending from the apex of the raised central ridge to the second base. The roller system includes a conveyor for advancing the packaging box toward the roller when the packaging box is upstream relative to the roller and away from the roller when the packaging box is downstream relative to the roller. The roller system includes a support frame positioned proximate to the conveyor, the roller movably coupled relative to the support frame such that the roller is movable from an idle position, where the roller is not in contact with the packaging tape of the packaging box moving on the conveyor and an active position, where the roller is in contact with the packaging tape of the packaging box moving on the conveyor for puncturing the packaging tape.

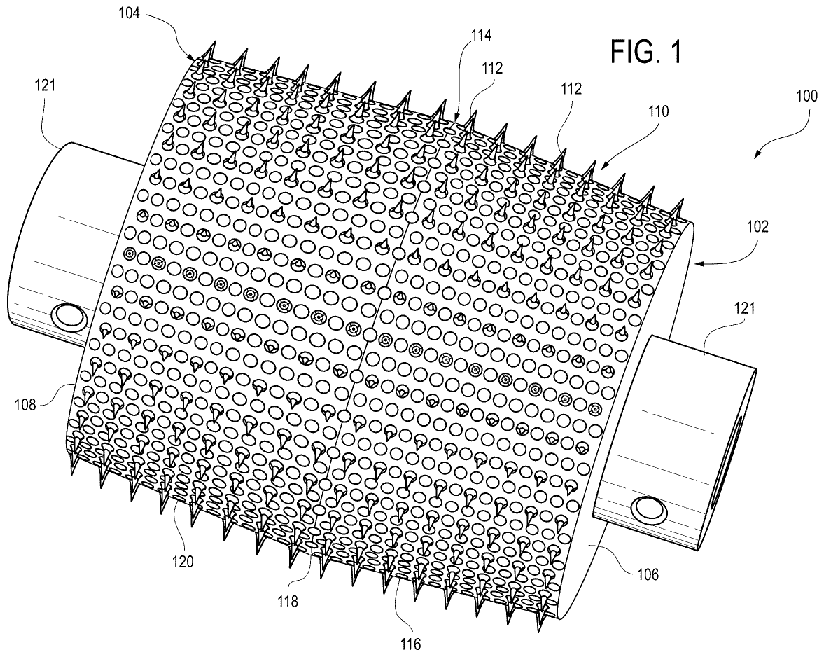

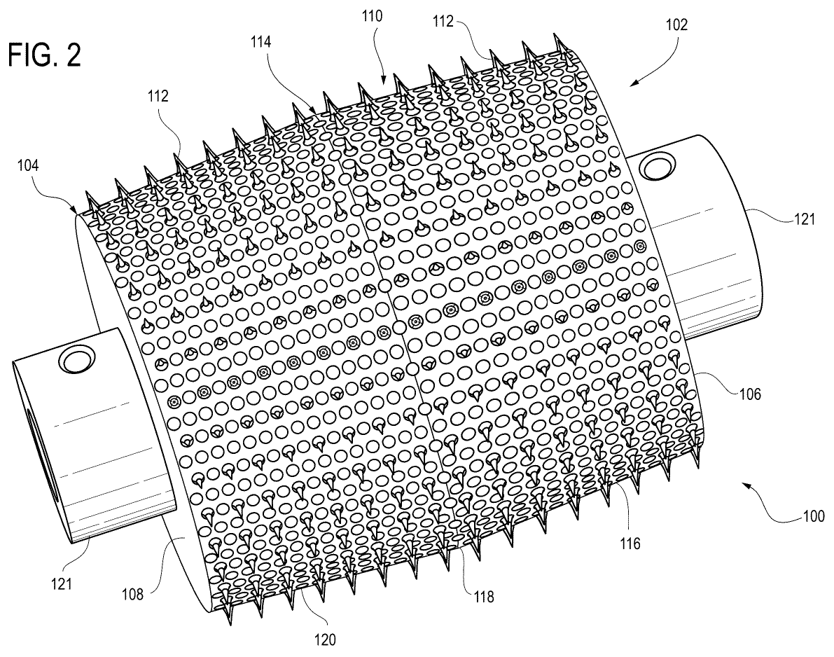

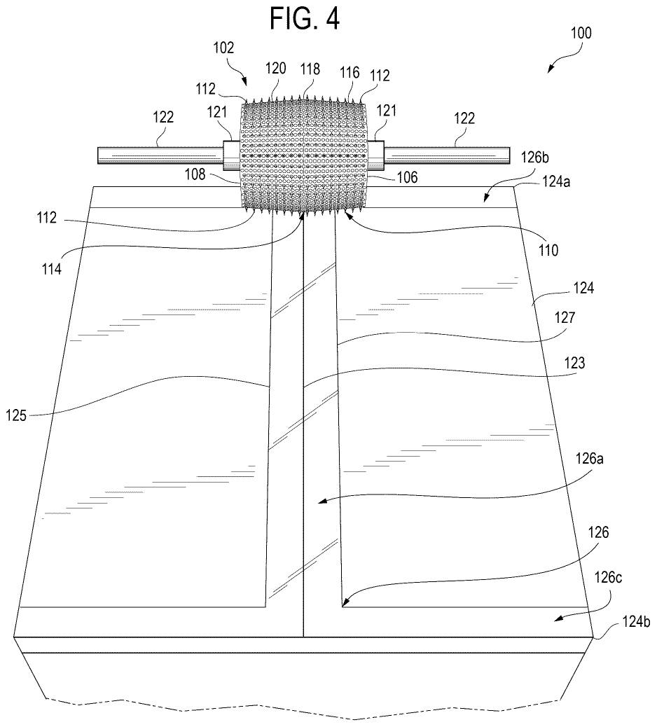

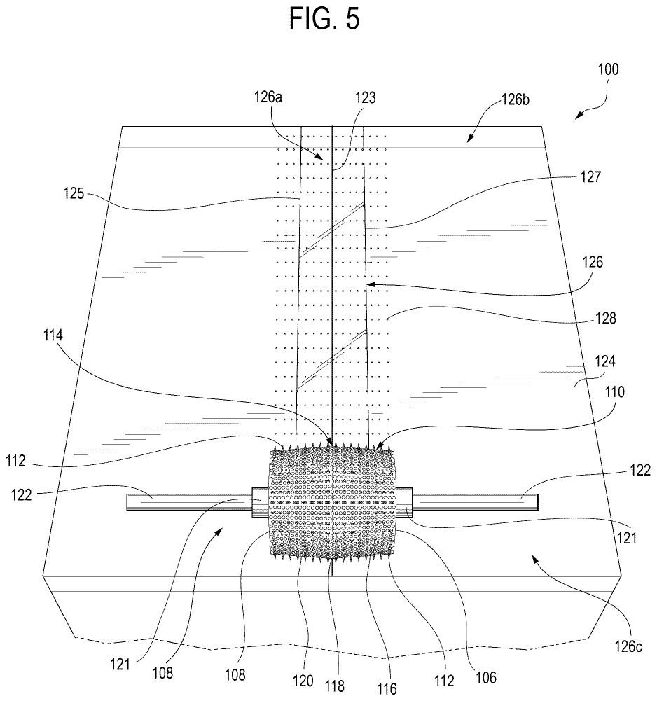

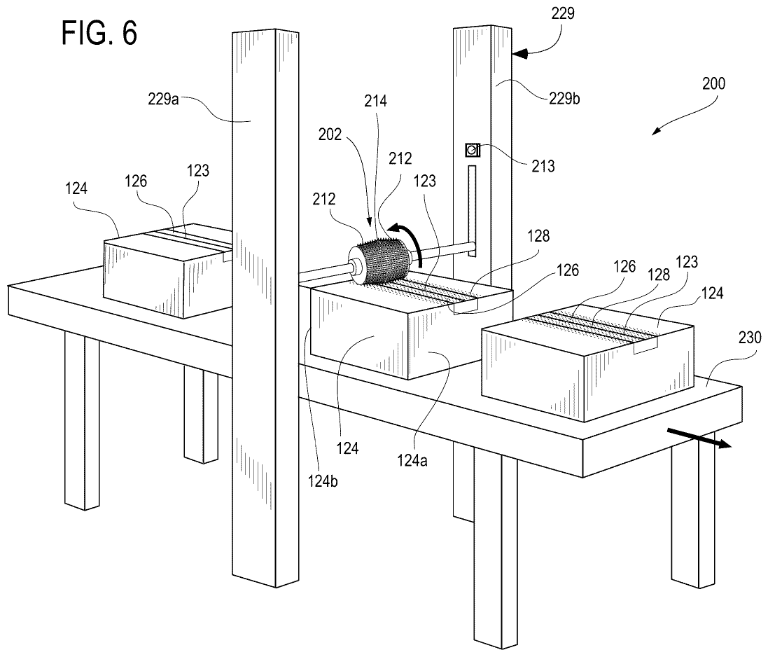

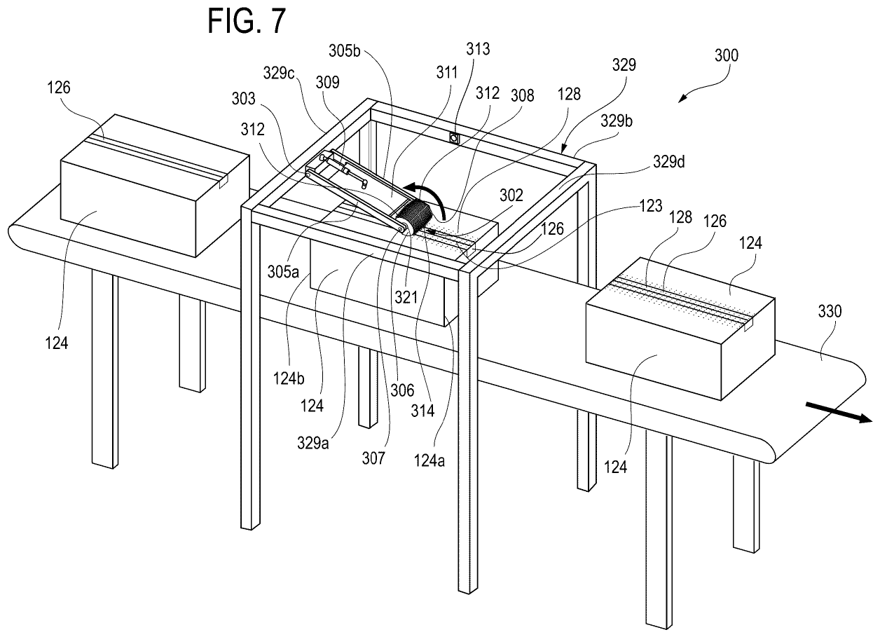

FIGS. 1-3 show a roller system 100 in accordance with some embodiments. Generally, the roller system 100 includes a roller 102 with a plurality of puncturing elements 112. In some aspects, the roller 102 is rolled across packaging tape (e.g., the packaging tape 126 shown in FIGS. 4-6), and the puncturing elements 112 perforate the packaging tape 126. Generally, the packaging tape 126 is perforated in order to allow an associate to more easily remove the packaging tape 126 from the box and to open a box more easily (e.g., the packaging box 124 shown in FIGS. 4-6). In some aspects, the roller system 100 is a manual system (e.g., as shown in FIGS. 4 and 5) operable by an operator (e.g., automated and/or human) such that the roller 102 is manually moved (e.g., rolled) relative to the packaging box 124. In some embodiments, the roller system 200, 300 is an automated system (e.g., as shown in FIGS. 6-7) such that at least the packaging box 124 is moved (e.g., on a conveyor) relative to the roller 202, 302 and into contact with the puncturing elements 212, 312 of the roller 202, 302. In some aspects, the roller 102 and/or the packaging box 124 may be moveable by the roller system 100.

The roller 102 may be any suitable roller in accordance with some embodiments. Generally, the roller 102 is rotated about an axis of rotation centered in the middle of the roller 102 and extending along a width of the roller 102. In the illustrated embodiment, the roller 102 has a cylindrical body 104 with a first base 106, a second base 108, and a curved side 110. The first base 106 and the second base 108 are generally circular in shape (though it is contemplated that alternate shapes may be used) and generally share the same axis of rotation as the roller 102, and the axis of rotation extends through the center of each of the first base 106 and the second base 108. In some aspects, the roller 102 is solid unitary piece between the first base 106 and the second base 108, while in some aspects, the roller 102 has a hollow interior.

The cylindrical body 104 of the roller 102 includes varying diameters along a width of the cylindrical body 104, which is defined by a distance from the first base 106 to the second base 108 across a surface of the curved side 110. In some aspects, the first base 106 is located opposite the second base 108, and the curved side 110 interconnects the first base 106 and the second base 108. Generally, the first base 106 has a first diameter and the second base 108 has a second diameter, and the first diameter and the second diameter are equal. It is contemplated that in some embodiments, the first diameter and the second diameter may not be equal.

In some embodiments, the curved side 110 includes multiple puncturing elements 112 disposed on a surface of the curved side 110 and extending radially therefrom. Generally, the puncturing elements 112 puncture the packaging tape 126 when the roller 102 is applied to and rolled over the packaging tape 126 of a packaging box 124. In some embodiments, the puncturing elements 112 are aligned to form a plurality of rows on the surface of the curved side 110. Generally, each row extends across substantially an entire width of the curved side 110. The puncturing elements 112 may include any suitable pin, spike, needle, and so forth. In the shown embodiments, the puncturing elements 112 are generally the same in size and/or shape, however, it is generally contemplated that the puncturing elements 112 may vary in size and/or shape such that multiple sizes and/or shapes of puncturing elements 112 are spaced along the curved side 110. In some aspects, the puncturing elements 112 may be moveable (e.g., retractable within the curved side 110) and/or interchangeable (e.g., such that the location and/or type of puncturing element 112 can be varied).

In some aspects, the curved side 110 includes a raised central ridge 114 continuously extending around a circumference of the curved side 110. In some aspects, the raised central ridge 114 includes an apex 118. In the illustrated embodiment, the curved side 110 has a maximum diameter defined by a circumference of the apex 118 of the raised central ridge 114 and a minimum diameter defined by any one of the first diameter of the first base 106 and the second diameter of the second base 108. While the raised central ridge 114 is shown to be disposed at a center of the roller 102 and being in a center between (and thus equidistant from) the first base 106 and the second base 108, in some aspects, the raised central ridge 114 and/or the apex 118 may not be centered between the first base 106 and the second base 108.

In some aspects, when pressure is applied to a surface (e.g., the packaging tape 126) of a packaging box 124 by the roller 102, the central portion of the packaging box 124 compresses downwardly in the direction of the pressure applied by the roller 102. It is generally contemplated that the apex 118 of the raised central ridge 114 of the curved side 110 of the roller 102, representing the greatest diameter of the curved side 110, in combination with first and second tapered portions 116, 120 of the curved side 110 (which will be described in more detail below), enable the roller 102 to perforate the packaging tape 126 on the packaging box 124 even if the center of the packaging box 124 is compressed in response to the application of pressure by the roller 102 to the packaging box 124.

In some embodiments, the curved side 110 includes a first tapered portion 116 extending from the apex 118 of the raised central ridge 114 to the first base 106 and a second tapered portion 120 extending from the apex 118 of the raised central ridge 114 to the second base 108 in a direction opposite of the first tapered portion 116. The first tapered portion 116 and the second tapered portion 120 are shown to be generally the same (e.g., in width from the apex 118 to the respective base 106, 108, in angle relative to the apex 118, in the rate of diameter change from apex 118 to respective base 106, 108, and so forth), however, it is generally contemplated that the tapered portions 116 and the tapered portions 120 may at least partly differ relative to one another in some embodiments.

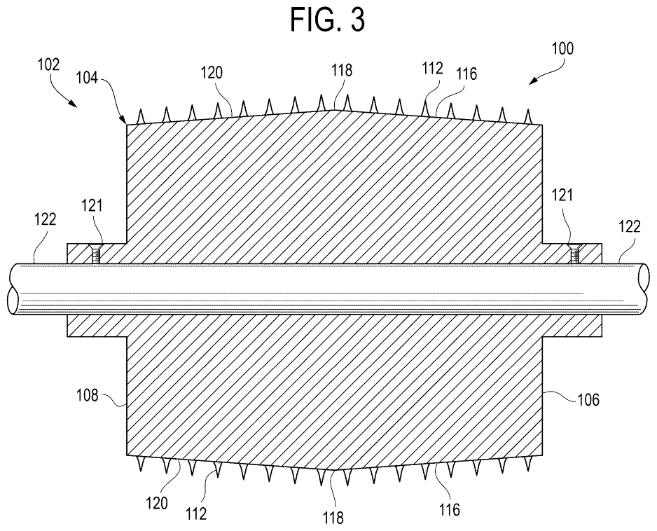

In some aspects, each of the first tapered portion 116 and the second tapered portion 120 is tapered at an angle of 10-20 degrees relative to a horizontal plane. In some aspects, the axis of rotation of the roller 102 extends through the horizontal plane. It is generally contemplated that the angle of the tapered portions 116, 120 is consistent around the circumference of the apex 118 such that each of the tapered portions 116, 120 has a generally cylindrical cross-section. As shown in FIG. 3, the angle of taper of each of the tapered portions 116, 120 generally varies the diameter of the cross-section such that the diameter of the roller 102 is the greatest at the apex 118 and decreases (e.g., linearly such that the tapered portions 116, 120 have flat surfaces and/or non-linearly such that the tapered portions 116, 120 have curved (e.g., convex or concave) surfaces) in a direction towards the bases 106, 108. In other words, in some aspects, the maximum diameter of the roller 102 is along a circumference of the apex 118 and the minimum diameter of the roller 102 is along a circumference of each of the first base 106 and/or the second base 108.

In some embodiments, the cylindrical body 104 of the roller 102 includes additional cylindrical bodies 121 extend outwardly from each of the first and second bases 106, 108. In some aspects, each of the cylindrical bodies 121 is positioned centrally relative to and extends outwardly (laterally) from each respective one of the first and second bases 106, 108. In some aspects, the additional cylindrical bodies 121 are used to couple the roller 102 with any additional structures (e.g., the handles 122 shown in FIGS. 4 and 5, the support frame 229 shown in FIG. 6, and so forth). In the illustrated embodiment, the additional cylindrical bodies 121 have a diameter that is significantly smaller (e.g., at least two times smaller in some aspects and at least three times smaller in some aspects) than a diameter of the first and second bases 106, 108 such that the cylindrical bodies 121 do not contact the packaging box 124 and/or the packaging tape 126 being perforated by the puncturing elements 112 of the roller 102. The additional cylindrical bodies 121 may have any suitable dimensions, locations on a respective base 106, 108, configuration, and so forth. In some aspects, the additional cylindrical bodies 121 are optional.

Further referring to FIGS. 4 and 5, the roller system 100 is shown in the context of perforating the packaging tape 126 of a packaging box 124 in accordance with some embodiments. The packaging box 124 is generally any suitable box (e.g., with variable dimensions, materials, items inside, and so forth) and the packaging tape 126 is any suitable type of tape for sealing boxes (e.g., carton sealing tape, acrylic tape, paper packing tape, etc.). Generally, the packaging box 124 is sealed shut with packaging tape 126. In the shown embodiments, the packaging box 124 is taped by the packaging tape 126 in an H-shape such that three strips of packaging tape 126 (e.g., two parallel strips 126b, 126c of the packaging tape 126 and one center strip 126a of the packaging tape 126 perpendicular to and in the middle of the two parallel strips 126b, 126c of the packaging tape 126) require perforation in order to easily open the packaging box 124. In the embodiment illustrated in FIG. 4, the center strip of the packaging tape 126 has a center line 123, a first edge 125, and a second edge 127 opposite the first edge, such that a width of the center strip of the packaging tape 126 is defined as a distance from the first edge 125 to the second edge 127 across the center line 123.

In the embodiment shown in FIG. 4, the width of the roller 102 (which, as mentioned above, is defined as the distance along the curved side 110 from the first base 106 to the second base 108) is greater than the width of the center strip 126a of the packaging tape 126 (which, as described above, is defined as a distance from the first edge 125 of the center strip 126a to the second edge 127 of the center strip 126a across the center line 123 of the center strip 126a). As such, when the roller 102 is rolled along the packaging box 124 from a position shown in FIG. 4 to a position shown in FIG. 5, the puncturing elements 112 of the roller 102 at least partially perforate the central strip 126a of the packaging tape 126 across an entire width of the central strip 126a of the packaging tape 126, and also perforate portions of the packaging box 124 that do not include the packaging tape 126 (which is shown in FIG. 5). As a result, the packaging box 124 is easily openable by a user after perforation of the packaging tape 126. In some embodiments, the roller 102 may have a width that is substantially equal to the width of the central strip 126a of the packaging tape 126 such that when the roller 102 is rolled along the packaging box 124 from a position shown in FIG. 4 to a position shown in FIG. 5, the puncturing elements 112 of the roller 102 at least partially perforate only the central strip 126a of the packaging tape 126 across an entire width of the central strip 126a of the packaging tape 126, but do not perforate portions of the packaging box 124 that do not include the packaging tape 126.

The width of the roller 102 from the first base 106 to the second base 108 may be any suitable width, however, it is generally contemplated that in preferred embodiments the width of the roller 102 at least perforates a portion of the two parallel strips 126b, 126c of the packaging tape 126 perpendicular to the central strip 126a of the packaging tape 126 in the middle of the packaging box 124 (e.g., the ends of the ‘H’ on an H-taped packaging box 124). In the embodiment shown in FIG. 4, the roller 102 is positioned with the raised central ridge 114 of the curved side 110 of the roller 102 being aligned (i.e., colinear) with a center line 123 of the central strip 126a of the packaging tape 126 on the packaging box 124. The center line 123 may be defined by (e.g., may be colinear with) a central longitudinal axis passing through the packaging tape 126. While an H-taped packaging box 124 is shown, it is generally contemplated that any alternate configuration of packaging tape 126 may be perforated/punctured by the puncturing elements 112 of the roller 102.

FIG. 4 shows the roller 102 positioned at a first end 124a of the packaging box 124 prior to puncturing the packaging tape 126, and FIG. 5 shows the roller 102 positioned at a second end 124b (opposite the first end 124a) of the packaging box 124 after perforation of the packaging tape 126 by the roller 102. FIG. 5 shows perforations 128 made by the puncturing elements 112 of the roller 102 when the roller 102 rolled across the central strip 126a of the packaging tape 126 on the packaging box 124. Generally, the perforations 128 are small holes made by the puncturing elements 112 of the roller 102 when the puncturing elements 112 of the roller 102 are pressed into the packaging tape 126 with a force great enough to puncture the packaging tape 126. The pattern of perforations 128 is shown to be linearly spaced (i.e., due to the puncturing elements 112 being aligned in rows and due to the roller 102 moving along the packaging tape 126 in a straight line), however, it is understood that the spacing of perforations 128 is based on the direction of movement of the roller 102 and based on the configuration of the puncturing elements 112 and that the roller 102 may be moved in a non-linear direction and that an alternate configuration of puncturing elements 112 would result in an alternate respective configuration of perforations 128.

In some embodiments, the roller system 100 may further include at least one handle 122 (two handles 122 are shown in FIGS. 3-5) coupled to the roller 102. Generally, the handle(s) 122 is/are coupled to the cylindrical body(ies) 121 extending from the first base 106 and second base 108. In some aspects, the handle(s) 122 permit a user to grasp the handle(s) 122 with both hands (i.e., one hand on each handle 122) and to roll the roller 102 over packaging tape 126 on the packaging box 124 in order to puncture the packaging tape 126. As shown in FIG. 3, the handles 122 may be formed by a single unitary structure (e.g., a rod) extending through the cylindrical body 104 of the roller 102 (e.g., when the roller 102 is at least partially hollow) and protruding from the cylindrical bodies 121. In some aspects, the handle 122 is coupled (e.g., with a screw and/or alternate fastener passing through a respective cylindrical body 121 extending outwardly from each base 106, 108).

FIG. 6 shows an automated roller system 200 according to some embodiments. In the embodiment illustrated in FIG. 6, the roller system 200 includes at least one conveyor 230. In some aspects, the conveyor 230 advances packaging boxes 124 in a first direction (e.g., from a location upstream of the roller 202 towards the roller 202 and from the roller 202 to a location downstream of the roller 202 as shown in FIG. 6 by the arrow at the end of the conveyor 230). It is generally contemplated that the conveyor 230 may be any suitable conveyor 230 including belt conveyors, motorized rollers, chain conveyors, overhead conveyors, and the like. There may be any number of conveyors 230 connected to one another that advance objects (i.e., the packaging boxes 124) thereon at least in a first direction towards the roller 202.

In the embodiment shown in FIG. 6, the roller system 200 includes a support frame 229 coupled with the roller 202. As shown in FIG. 6, the support frame 229 is a structure coupled to the conveyor 230 that includes two support members 229a, 229b (e.g., beams, posts, etc.) on either side of the conveyor 230. Each of the support members 229a, 229b generally includes a coupling mechanism (e.g., a recess, a slot, a latch, a pivot, etc.) moveably couple to the roller 202. In some aspects, the roller 202 is coupled to the support frame 229 such that the roller 202 is positioned above the conveyor 230 and rotatable about the axis of rotation of the roller 202 (shown by a directional arrow in FIG. 6).

In some embodiments, the support frame 229 and the roller 202 are coupled such that the roller 202 is permitted to movable linearly relative to the packaging box 124 (e.g., up and down and side-to-side, horizontally, etc.). In one example, the roller 202 is coupled to the support frame 229 such that the roller 202 is permitted to move downwardly in a direction towards a packaging box 124 moving on the conveyor 230 and/or permitted to move upwardly in a direction away from a packaging box 124 moving on the conveyor 230. In another example, the roller 202 is coupled to the support frame 229 such that the roller 202 is permitted to move side-to-side in the direction of either one of the support members 229a, 229b such that the raised central ridge 214 of the roller 202 may be aligned with a center line 123 of the packaging tape 126 on the packaging box 124 to facilitate the puncturing of the packaging tape 126 by the puncturing elements 212 of the roller 202 when the puncturing elements 212 contact and roll over the packaging tape 126. In certain aspects, the roller 202 is coupled to the support frame 229 such that a force is applied by the puncturing elements 212 of the roller 202 onto the packaging tape 126 to facilitate the puncturing of the packaging tape 126 by the puncturing elements 212 of the roller 202 when the puncturing elements 212 contact and roll over the packaging tape 126.

In the embodiment illustrated in FIG. 6, the roller 202 is coupled relative to the support frame 229 such that the roller 202 is permitted to rotate in a direction opposite the direction of movement of the conveyor 230 about an axis of rotation of the roller 202 (shown in FIG. 6 by a curved directional arrow). As shown in FIG. 6, the direction of movement of the conveyor 230 is generally to the right (shown in FIG. 6 by a straight directional arrow), and the direction of rotation of the roller 202 is generally counterclockwise. Any alternate directions may be used such that when a packaging box 124 is moved on the conveyor 230, a first end 124a of the packaging box 124 that is the leading end of the packaging box 124 based on the direction of travel of the conveyor 230 is perforated before a second end 124b of the packaging box 124 opposite the first end 124a that is the trailing end of the packaging box 124 based on the direction of travel of the conveyor 230. As shown in FIG. 6, the packaging box 124 upstream of the roller 202 does not yet have perforations 128 on the packaging tape 126 (because it has not yet passed under the roller 202 and has not yet been contacted by the puncturing elements 212 of the roller 202) and the packaging box 124 downstream of the roller 202 does have perforations 128 on the packaging tape 126 (because it has already passed under the roller 202 and has already been contacted by the puncturing elements 212 of the roller 202).

In some aspects, the conveyor 230 and/or ancillary mechanisms (e.g., omnidirectional rollers, multi-directional conveyor belts, etc.) coupled to the conveyor 230 may center the packaging box 124 on the conveyor 230 such that a center line 123 of the packaging tape 126 on the packaging box 124 is aligned with the raised central ridge 214 of the roller 202. In some aspects, the roller 202 is moved (e.g., horizontally) in order to align the raised central ridge 214 of the roller 202 with the center line 123 of the packaging tape 126, while in some aspects the packaging box 124 is moved on the conveyor 230 in order to align the center line 123 of the packaging tape 126 with the raised central ridge 214 of the roller 202.

In some aspects, the roller system 200 may include one or more suitable sensor 213 (e.g., cameras, proximity sensors, position sensors, etc.) that may detect if the center line 123 of the packaging tape 126 of a packaging box 124 is aligned with the raised central ridge 214 of the roller 202, which, in cases when it is detected that the packaging tape 126 and the roller 202 are not in alignment, would then cause the roller system 200 to responsively cause (e.g., via a control circuit communicating with the conveyor 230) alignment of the packaging tape 126 of the packaging box 124 and the roller 202 (e.g., by adjusting the position of the roller 202 or the position of the packaging box 124). In some aspects, the center line 123 of the packaging tape 126 on the packaging box 124 is manually aligned (e.g., by a human or a robotic operator) with the raised central ridge 214 of the roller 202. The sensor 213 in FIG. 6 is shown in a location on the second support member 229b, but it will be appreciated that the sensor 213 may be located in a different location on the second support member 229b or may be on the first support member 229a.

The support frame 229 and first and second support members 229a, 229b shown in FIG. 6 are an example embodiment, and it will be appreciated that the roller may be movably coupled to a different support frame, and may be coupled to the different support frame via a different mechanism such that the puncturing elements 212 of the roller 202 may come into contact (e.g., with a biasing force) with the packaging tape 126 of a packaging box 124 moving on the conveyor 230 to puncture the packaging tape 126 along a full length of the packaging tape 126.

FIG. 7 shows another automated roller system 300 according to some embodiments. Like the roller system 200, the roller system 300 includes at least one conveyor 330. In some aspects, the conveyor 330 advances packaging boxes 124 in a first direction (e.g., from a location upstream of the roller 302 towards the roller 302 and from the roller 302 to a location downstream of the roller 302 as shown in FIG. 7 by the arrow at the end of the conveyor 330). Just like the conveyor 330, the conveyor 330 may be any suitable conveyor 330 including belt conveyors, motorized rollers, chain conveyors, overhead conveyors, and the like. There may be any number of conveyors 330 connected to one another that advance objects (i.e., the packaging boxes 124) thereon at least in a first direction towards the roller 302.

In the embodiment shown in FIG. 7, the roller 302 of the roller system 300 is coupled to a support frame 329 that is different from the support frame shown in FIG. 6, and is coupled to the support frame 329 differently. In particular, in the embodiment shown in FIG. 6, the support frame 329 is positioned adjacent the conveyor 330 and is not directly coupled to the conveyor 330 (although, in some embodiments, the support frame 329 may be directly coupled to the conveyor 330). The example support frame 329 shown in FIG. 7 includes four support members 329a, 329b, 329c, 329d that are arranged in a form of a rectangle, with support members 329a, 329b extending opposite each other on each side of the conveyor 330 along a direction of movement of the conveyor 330 (shown by the directional arrow in FIG. 7), and support members 329c, 329d interconnecting the support members 329a, 329b and extending across the conveyor 330 in a direction transverse to the direction of movement of the conveyor 330.

In the embodiment shown in FIG. 7, the support frame 329 and the roller 302 are coupled to each other via two support arms 305a, 305b that are coupled to a pivot 303 that is mounted on the support frame 329 (in this example, on the support member 329c). In the embodiment illustrated in FIG. 7, the support arms 305a, 305b are interconnected by a connecting member such as an interconnecting plate 311, but it will be appreciated that, in some embodiments, the support arms 305a, 305b are spaced apart from each other and not interconnected by the interconnecting plate 311.

In particular, in the illustrated embodiment, the roller 302 is coupled to the pivot 303 via a first arm 305a and a second arm 305b, which are in turn coupled (e.g., via one or more pins 307) to the cylindrical bodies 321 extending from each of the first and second bases 306, 308. In the illustrated configuration, the first and second arms 305a, 305b are permitted to move about the pivot 303 relative to the support frame 329 (and move in a direction toward or away from a packaging box 124 moving on the conveyor 330), while the roller 302 is permitted to rotate relative to the first and second support arms 305a, 305b about a rotational axis shown by a directional arrow in FIG. 7 (and thus roll over the packaging tape 126 of the packaging box 124 moving on the conveyor 330 such that the puncturing elements 312 of the roller 302 contact and puncture the packaging tape 126.

In certain aspects, the roller 302 is coupled to the support frame 329 such that a force is applied by the puncturing elements 312 of the roller 302 onto the packaging tape 126 to facilitate the puncturing of the packaging tape 126 by the puncturing elements 312 of the roller 302 when the puncturing elements 312 of the roller 302 contact and roll over the packaging tape 126.

In the embodiment shown in FIG. 7, the roller 302 is coupled relative to the support frame 329 such that the arms 305a, 305b are coupled to an actuator 309 (e.g., a motor, a pneumatic cylinder, etc.) that is operatively coupled to the interconnecting plate 311 and that causes the interconnecting plate 311 and, consequently, the arms 305a, 305b coupled to the interconnecting plate 311 to not only move upwardly and downwardly about the pivot 303 relative to the packaging tape 126 of the packaging box 124 moving on a conveyor, but may also generate a force that biases the arms 305a, 305b and the roller 302 coupled to the arms in a downwardly direction toward the packaging tape 126 on the packaging box 124 to facilitate the puncturing of the packaging tape 126 by the puncturing elements 312 of the roller 302 when the puncturing elements 312 contact and roll over the packaging tape 126. In other words, in certain aspects, the roller 302 is coupled to the support frame 329 such that a force is applied by the puncturing elements 312 of the roller 302 onto the packaging tape 126 to facilitate (i.e., by applying this force) the puncturing of the packaging tape 126 by the puncturing elements 312 of the roller 302 when the puncturing elements 312 contact and roll over the packaging tape 126.

In the embodiment depicted in FIG. 7, the roller 302 is coupled relative to the support frame 329 such that the roller 302 is permitted to rotate in a direction opposite the direction of movement of the conveyor 330 (as indicated by a directional arrow) about an axis of rotation of the roller 302. As shown in FIG. 7, the direction of movement of the conveyor 330 is generally to the right, and the direction of rotation of the roller 302 is generally counterclockwise. Any alternate directions may be used such that when a packaging box 124 is moved on the conveyor 330, a first end 124a of the packaging box 124 that is the leading end of the packaging box 124 based on the direction of travel of the conveyor 330 is perforated before a second end 124b of the packaging box 124 opposite the first end 124a that is the trailing end of the packaging box 124 based on the direction of travel of the conveyor 330.

As shown in FIG. 7, the packaging box 124 upstream of the roller 302 does not yet have perforations 128 on the packaging tape 126 (because it has not yet passed under the roller 302 and has not yet been contacted by the puncturing elements 312 of the roller 302) and the packaging box 124 downstream of the roller 302 does have perforations 128 on the packaging tape 126 (because it has already passed under the roller 302 and has already been contacted by the puncturing elements 312 of the roller 302).

In some aspects, the conveyor 330 and/or ancillary mechanisms (e.g., omnidirectional rollers, multi-directional conveyor belts, etc.) coupled to the conveyor 330 may center the packaging box 124 on the conveyor 330 such that a center line 123 of the packaging tape 126 on the packaging box 124 is aligned with the raised central ridge 314 of the roller 302. In some aspects, the roller system 300 may include one or more suitable sensors 313 (e.g., cameras, proximity sensors, position sensors, etc.) that may detect if the center line 123 of the packaging tape 126 of a packaging box 124 is aligned with the raised central ridge 314 of the roller 302, which, in cases when it is detected that the packaging tape 126 and the roller 302 are not in alignment, would then cause the roller system 300 to responsively cause (e.g., via a control circuit communicating with the conveyor 330) alignment of the packaging tape 126 of the packaging box 124 and the roller 302 (e.g., by adjusting the position of the packaging box 124 on the conveyor 330). In some aspects, the center line 123 of the packaging tape 126 on the packaging box 124 is manually aligned (e.g., by a human or a robotic operator) with the raised central ridge 314 of the roller 302.

In some aspects, some of the components of the roller systems 200 and 300 are controllable by a control circuit. For example, a control circuit may receive sensor data from a sensor 213, 313 positioned proximate the conveyor, and to determine whether the sensor data from the sensor indicates whether the center line 123 of the packaging tape 126 on the packaging box 124 is aligned with the raised center ridge 214, 314 of the roller 202, 302.

A control circuit is a processor-based control circuit in accordance with some embodiments. In some aspects, the control circuit may include any suitable processing resource that executes instructions stored in a computer-readable storage memory (e.g., a non-transitory, computer-readable storage medium). In this context, the terms control circuit and controller refer broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components, devices, sensors, motors, etc. The control circuit or controller may (for example, by using corresponding programming stored in a memory as will be well understood by those skilled in the art) carry out one or more of the steps, actions, and/or functions described herein.

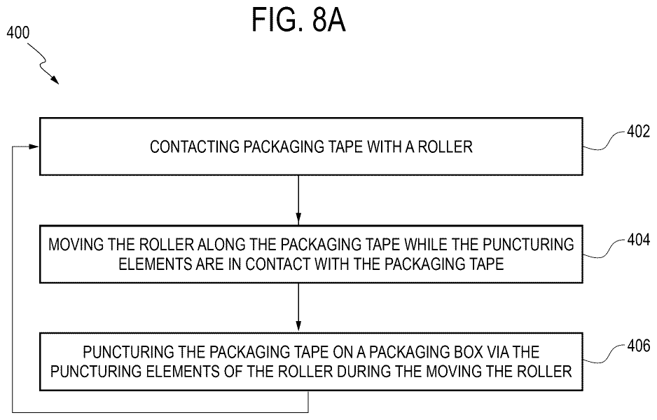

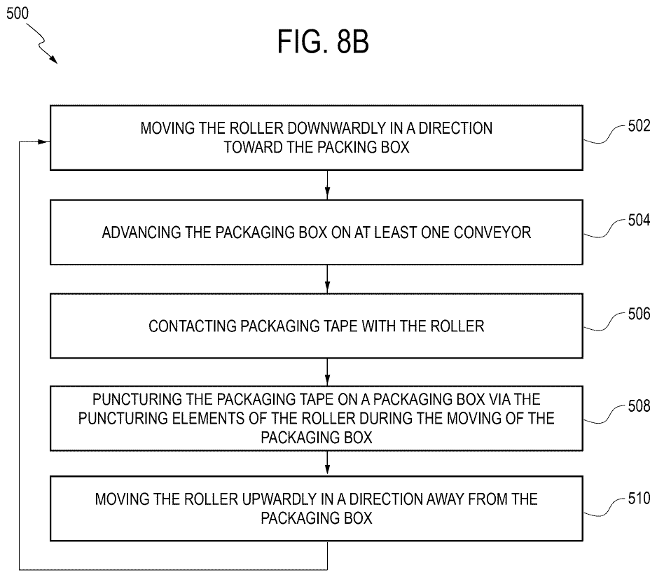

FIGS. 8A and 8B show methods 400 and 500, respectively in accordance with some embodiments. It is generally contemplated that the methods 400 and 500 may be implemented by the roller systems 100, 200, and/or 300. The method 400 of FIG. 8A may be implemented by a manual roller system in accordance with some embodiments. The method 500 of FIG. 8B may be implemented by an automated roller system in accordance with some embodiments.

Referring to FIG. 8A, the method 400 includes a step 402 of contacting packaging shape with a roller. The roller generally includes a cylindrical body having a first base with a first diameter, a second base having a second diameter located opposite the first base, and a curved side interconnecting the first base and the second base. In some aspects, the first diameter and the second diameter are equal. In some embodiments, the curved side includes a plurality of puncturing elements disposed on a surface of the curved side and extending radially therefrom. In some aspects, the puncturing elements include spikes or pins, and the spikes or pins are aligned to form a plurality of rows on the surface of the curved side. Each of the rows generally extends across substantially an entire width of the curved side defined by a distance between the first base and the second base. The curved surface, in some aspects, may include a raised central ridge continuously extending around a circumference of the curved side, a first tapered portion extending from an apex of the raised central ridge to the first base, and a second tapered portion extending from the apex of the raised central ridge to the second base. In some embodiments, each of the first tapered portion and the second tapered portion is tapered at an angle of 10-20 degrees relative to a horizontal plane. In some aspects, the cylindrical body has a maximum diameter defined by a circumference of the apex of the raised central ridge and a minimum diameter defined by one of the first diameter of the first base and the second diameter of the second base.

Step 404 of the method 400 includes moving the roller along the packaging tape while the puncturing elements of the roller are in contact with the packaging tape. In some aspects, the puncturing elements puncture the packaging tape when the roller is applied to and rolled over the packaging tape of the packaging box. In some embodiments, the method further includes permitting a user to grasp at least one handle coupled to the roller and extending from at least one of the first base and the second base and to roll the roller over the packaging tape on the packaging box while grasping the at least one handle to puncture the packing tape. At step 406, the method 400 includes puncturing the packaging tape on the packaging box via the puncturing elements of the roller during the moving of the roller along the packaging tape while the puncturing elements of the roller are in contact with the packaging tape.

Referring to FIG. 8B, the method 500 may optionally include a step 502 of moving the roller downwardly in a direction toward the packaging box and a step 504 of advancing the packaging box on at least one conveyor in a first direction. The roller may be coupled to a support frame such that the roller is position above the conveyor and permitted to rotate in a direction opposite to the first direction when the puncturing elements of the roller come into contact with at least the packaging tape of the packaging box moving in the first direction on the at least one conveyor. Generally, the roller is coupled to the support frame such that the roller is positioned with the raised central ridge of the curved side of the roller being aligned with a center (e.g., center line) of the packaging tape on the packaging box. In some aspects, the center is defined by a central longitudinal axis passing through the packaging tape.

As shown in FIG. 8B, step 506 of contacting the packaging tape with the roller may follow the step 504 of advancing the packaging box on the conveyor. At step 508, the method 500 may include puncturing the packaging tape of the packaging box via the puncturing elements of the roller when the puncturing elements of the roller come into contact with at least the packaging tape of the packaging box moving in the first direction on the at least one conveyor. At step 510, the method 500 may include moving the roller upwardly in a direction away from the packaging box.

Generally, the systems and methods described herein utilize a tapered roller with puncturing elements to perforate packaging tape on packaging boxes in order to allow a packaging box to be more easily opened. Conventional perforation methods including chemically (e.g., spraying and/or brushing chemicals to disintegrate packaging tape), thermally (e.g., burning and/or melting packaging tape), and/or mechanically (e.g., slicing, punching, and/or pulling packaging tape) cause safety hazards, are inefficient, lack precision, require large amounts of space, and are costly. The systems and methods described herein perforate packaging tape effectively while being cost-effective, simple, safe, and/or scalable (e.g., for use in an automated mechanism and/or for manual use). In other words, the systems and methods described herein facilitate reliable, efficient, and safe opening of taped packaging boxes, and are suitable for both manual and automated implementations.

Those skilled in the art will recognize that a wide variety of other modifications, alterations, and combinations can also be made with respect to the above described embodiments without departing from the scope of the disclosure.

1-16. (canceled)

17. A roller system for puncturing packaging tape on a packaging box, the roller system comprising:
a roller including:
a plurality of puncturing elements extending radially therefrom, the puncturing elements to puncture the packaging tape when the roller is applied to and rolled over the packaging tape of the packaging box;
a conveyor for advancing the packaging box toward the roller when the packaging box is upstream relative to the roller and away from the roller when the packaging box is downstream relative to the roller; and
a support frame positioned proximate to the conveyor, the roller movably coupled relative to the support frame such that the roller is movable from an idle position, where the roller is not in contact with the packaging tape of the packaging box moving on the conveyor, and an active position, where the roller is in contact with the packaging tape of the packaging box moving on the conveyor for puncturing the packaging tape.

18. The roller system of claim 17, further comprising:
a first arm coupled to the support frame and to the roller; and
a second arm coupled to the support frame and to the roller;
wherein, when the roller comes into the contact with the packaging tape of the packaging box moving on the conveyor, the first and second arms are coupled to the roller such that the roller is permitted to rotate in a direction from a leading edge of the packaging box to a trailing edge of the packaging box.

19. The roller system of claim 18, further comprising an actuator coupled to the support frame and to the first arm and the second arm, wherein the actuator causes the first arm and the second arm to rotate relative to a pivot, and wherein the actuator generates a downwardly force that causes the puncturing elements of the roller to apply a downwardly force onto the packaging tape of the packaging box to puncture the packaging tape.

20. The roller system of claim 19, further comprising:
at least one sensor that detects a position of the packaging box moving on the conveyor and indicates whether a center line of the packaging tape on the packaging box is aligned with the roller;
wherein the conveyor adjusts the position of the packaging box moving on the conveyor such that the center line of the packaging tape on the packaging box is aligned with the roller; or
wherein a position of the roller such that the roller is aligned with the center line of the packaging tape on the packaging box.

21. The roller system of claim 20, wherein the at least one sensor comprises at least one of a camera, a proximity sensor, and a position sensor.

22. The roller system of claim 20, further comprising a control circuit to receive sensor data from the at least one sensor and, based on the sensor data, cause alignment of the center line of the packaging tape on the packaging box with the roller.

23. The roller system of claim 20, wherein the conveyor comprises at least one of a belt conveyor, motorized rollers, a chain conveyor, and an overhead conveyor, and wherein the conveyor is to center the packaging box on the conveyor such that the center line of the packaging tape on the packaging box is aligned with the roller.

24. The roller system of claim 17, wherein the puncturing elements comprise spikes or pins, and wherein the spikes or pins are aligned to form a plurality of rows on a surface of the roller, each of the rows extending across substantially across a width of the roller.

25. The roller system of claim 17, wherein the roller is coupled to the support frame such that the roller is positioned above the conveyor and permitted to rotate in a direction opposite to a direction of movement of the conveyor when the puncturing elements of the roller come into contact with at least the packaging tape of the packaging box moving on the conveyor to puncture the packaging tape of the packaging box.

26. The roller system of claim 17, wherein the roller is movably coupled to the support frame such that the roller is permitted to move downwardly in a direction toward the packaging box moving on the conveyor and to move upwardly in a direction away from the packaging box moving on the conveyor.

27. The roller system of claim 17, wherein the roller is coupled to the support frame such that the roller is positioned in alignment with a center line of the packaging tape on the packaging box, the center line being defined by a central longitudinal axis passing through the packaging tape.

28. The roller system of claim 17, wherein the roller has a greater width than the packaging tape, and wherein when the roller rolls along the packaging box, the puncturing elements perforate the packaging tape across the width of the packaging tape.

29. The roller system of claim 18, further comprising an interconnecting plate coupling the first arm to the second arm.

30. The roller system of claim 19, wherein the actuator comprises at least one of a motor and a pneumatic cylinder.

31. A method of puncturing packaging tape on a packaging box using a roller system, the method comprising:
advancing, by a conveyor, the packaging box toward a roller when the packaging box is upstream relative to the roller, the roller movably coupled to a support frame positioned proximate to the conveyor and including a plurality of puncturing elements extending radially therefrom;
moving the roller from an idle position, where the roller is not in contact with the packaging tape of the packaging box moving on the conveyor, to an active position, where the roller is in contact with the packaging tape of the packaging box moving on the conveyor;
puncturing the packaging tape by applying the roller in the active position to and rolling the roller over the packaging tape of the packaging box; and
advancing, by the conveyor, the packaging box away from the roller when the packaging box is downstream relative to the roller.

32. The method of claim 31, wherein the roller is coupled to a first arm coupled to the support frame, and wherein the roller is coupled to a second arm coupled to the support frame, and further comprising rotating the roller in a direction from a leading edge of the packaging box to a trailing edge of the packaging box when the roller comes into contact with the packaging tape of the packaging box moving on the conveyor.

33. The method of claim 32, further comprising:
causing, by an actuator coupled to the support frame and to the first arm and the second arm, the first arm and the second arm to rotate relative to a pivot; and
generating, by the actuator, a downward force that causes the puncturing elements of the roller to apply a downward force onto the packaging tape of the packaging box to puncture the packaging tape.

34. The method of claim 33, further comprising:
detecting, by at least one sensor, a position of the packaging box moving on the conveyor;
indicating, by the at least one sensor, whether a center line of the packaging tape on the packaging box is aligned with the roller; and
adjusting, by the conveyor, the position of the packaging box moving on the conveyor such that the center line of the packaging tape on the packaging box is aligned with the roller, or adjusting a position of the roller such that the roller is aligned with the center line of the packaging tape on the packaging box.

35. The method of claim 31, further comprising rotating the roller, when the roller is positioned above the conveyor and when the puncturing elements come into contact with at least the packaging tape of the packaging box moving on the conveyor, in a direction opposite to a direction of movement of the conveyor to puncture the packaging tape of the packaging box.

36. The method of claim 31, further comprising:
moving the roller downwardly in a direction toward the packaging box moving on the conveyor; and
moving the roller upwardly in a direction away from the packaging box moving on the conveyor.
